(19) United States
(12) Patent Application Publication
(10) Pub. No.: US 2010/0008068 A1
(43) Pub. Date: Jan. 14, 2010

(54) ELECTRON EMISSION DEVICE, ELECTRON EMISSION TYPE BACKLIGHT UNIT INCLUDING THE SAME AND METHOD OF FABRICATING THE ELECTRON EMISSION DEVICE

(76) Inventors: Joo-Young Kim, Suwon-si (KR); Byong Gon Lee, Suwon-si (KR)

Correspondence Address: CHRISTIE, PARKER & HALE, LLP, PO BOX 7068, PASADENA, CA, 91109-7068, US

(21) Appl. No.: 12/502,103

(22) Filed: Jul. 13, 2009

Related U.S. Application Data
(60) Provisional application No. 61/080,179, filed on Jul. 11, 2008.

(30) Foreign Application Priority Data
Jul. 16, 2008 (KR) 10-2008-0069302

(51) Int. Cl. G09F 13/08; H01J 1/00; H01J 9/02

(52) U.S. Cl. 362/97.1; 313/235; 445/35

(57) ABSTRACT

An electron emission device, useful as a backlight unit, improves uniformity between pixels and maximizes post-processing effects. The electron emission device includes a base substrate with first electrodes extending on the base substrate, each of which includes a resistance layer formed at an end. The electron emission device also includes second electrodes electrically insulated from the first electrodes and electron emission sources formed on the first electrodes. The electron emission device is configured for current to flow through the resistance layer during a driving operation and for current to not flow through the resistance layer during an aging operation.

### CROSS-REFERENCE TO RELATED APPLICATION

This application claims priority to and the benefit of Korean Patent Application No. 10-2008-0069302, filed on Jul. 16, 2008, in the Korean Intellectual Property Office, the disclosure of which is incorporated herein in its entirety by reference.

### BACKGROUND OF THE INVENTION

1. Field of the Invention

The present invention relates to electron emission devices.

2. Description of the Related Art

Electron emission devices use thermionic cathodes or cold cathodes as electron emission sources. Types of electron emission devices that use cold electrodes include field emission devices (FEDs), surface conduction emitter (SCE) devices, metal-insulator-metal (MIM) devices, metal-insulator-semiconductor (MIS) devices, and ballistic electron surface emitting (BSE) devices.

FEDs operate on the principle that electrons are readily emitted due to an electric field difference in a vacuum when a material having a low work function or a high β function is used as an electron emission source. Electron emission sources formed of materials including molybdenum (Mo) or silicon (Si) as the main material and having a sharp tip, a carbon material such as graphite, a diamond like carbon (DLC), or a nanomaterial such as nanotubes or nanowires have been recently developed.

In conventional electron emission type backlight units using FEDs, a resistance layer is formed on each of a plurality of electron emission sources so as to improve uniformity between pixels. Post-processing such as aging and firing is also desired to improve uniformity between pixels. However, when a resistance layer is formed on each electron emission source, current flow is limited and post-processing efficiency is reduced. Thus, it is difficult to obtain desired electron emission characteristics.

In addition, since the resistance layer is deposited on each electron emission source, the process of manufacturing such an electron emission device is complicated and manufacturing costs increase. In addition, it is difficult to change resistance values after a resistance layer has been deposited on each electron emission source.

### SUMMARY OF THE INVENTION

Aspects of embodiments of the present invention are directed toward an electron emission device with improved uniformity between pixels and improved or optimum post-processing effects, an electron emission type backlight unit including the same, and a method of fabricating the electron emission device.

An embodiment of the present invention provides an electron emission device including: a base substrate; first electrodes extending in a first direction on the base substrate, each first electrode including a resistance layer at an end of the first electrode; second electrodes electrically insulated from the first electrodes; and electron emission sources on the first electrodes, wherein it is variable whether or not current flows through the resistance layer.

The electron emission device may be configured so that current does not flow through the resistance layer when an aging operation is performed and current flows through the resistance layer when a driving operation is performed.

The resistance layer may be on a first portion of each of the first electrodes, and each first electrode may further include a second portion protruding from one side of the first portion.

The electron emission device may be configured so that when an aging operation is performed, current flows through the second portion and when a driving operation is performed, current flows through the first portion.

The electron emission device may be configured so that when an aging operation is performed, a circuit for driving the electron emission device is electrically connected to the second portion and when a driving operation is performed, the circuit for driving the electron emission device is electrically connected to the first portion.

The electron emission device may further include a shorting bar crossing and electrically connecting the first electrodes.

The shorting bar may be located at one side of the resistance layer so that current does not flow through the resistance layer when an aging operation is performed.

Another embodiment of the present invention provides an electron emission type backlight unit including: an electron emission device including: a base substrate; first electrodes extending in a first direction on the base substrate, each first electrode including a resistance layer at an end of the first electrode; second electrodes electrically insulated from the first electrodes; and electron emission sources on the first electrodes; a phosphor layer facing each of the electron emission sources of the electron emission device; and a third electrode for accelerating electrons emitted from the electron emission device toward the phosphor layer.

Yet another embodiment of the present invention provides a method of fabricating an electron emission device, the method including: forming electrodes on a base substrate; forming a resistance layer at one end of each of the electrodes; performing an aging operation without current flowing through the resistance layer; and electrically connecting a circuit for driving the electron emission device to the electrodes so that current flows through the resistance layer.

Each of the electrodes may include a first portion on which the resistance layer is formed and a second portion protruding from one side of the first portion.

In the performing of the aging operation, current may flow through the second portion, and in the electrically connecting of the circuit for driving the electron emission device to the electrodes, current may flow through the first portion.

In the performing of the aging operation, the circuit for driving the electron emission device may be electrically connected to the second portion, and in the electrically connecting of the circuit for driving the electron emission device to the electrodes, the circuit for driving the electron emission device may be electrically connected to the first portion.

Before the performing an aging operation, the method may further include disposing a shorting bar across the first electrodes; and after the performing of the aging operation, the method may further include removing the shorting bar.

The shorting bar may not allow current to flow through the resistance layer.

### BRIEF DESCRIPTION OF THE DRAWINGS

The above and other aspects and features of the present invention will become more apparent by describing in detail exemplary embodiments thereof with reference to the attached drawings in which:

FIG. 1 is a schematic, partially-cut perspective view of a structure of an electron emission type backlight unit according to an embodiment of the present invention;

FIG. 2 is a cross-sectional view of the electron emission type backlight unit of FIG. 1 taken along the line II-II of FIG. 1, according to an embodiment of the present invention;

FIG. 3 is a schematic, partially-cut perspective view of a structure of an electron emission type backlight unit according to another embodiment of the present invention; and

FIGS. 4A and 4B are schematic perspective views for explaining operations of the electron emission type backlight unit illustrated in FIG. 3, according to embodiments of the present invention.

### DETAILED DESCRIPTION

The present invention will now be described more fully with reference to the accompanying drawings, in which exemplary embodiments of the invention are shown. Throughout this specification and the claims that follow, when an element is referred to as being “on” another element, it can be directly on the other element or be indirectly on the other element with one or more intervening elements interposed therebetween.

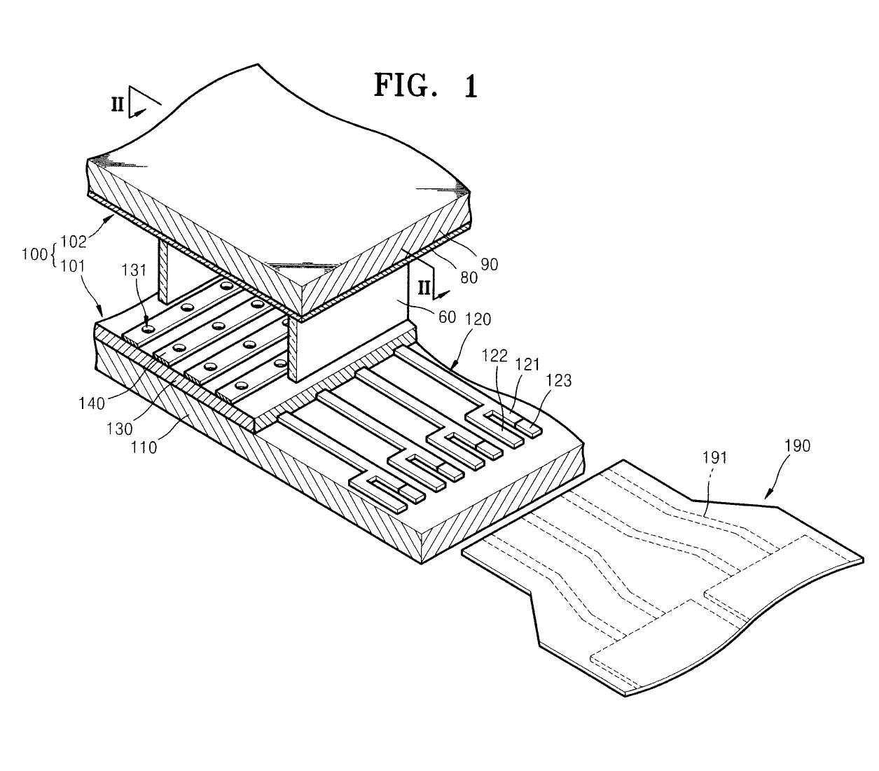

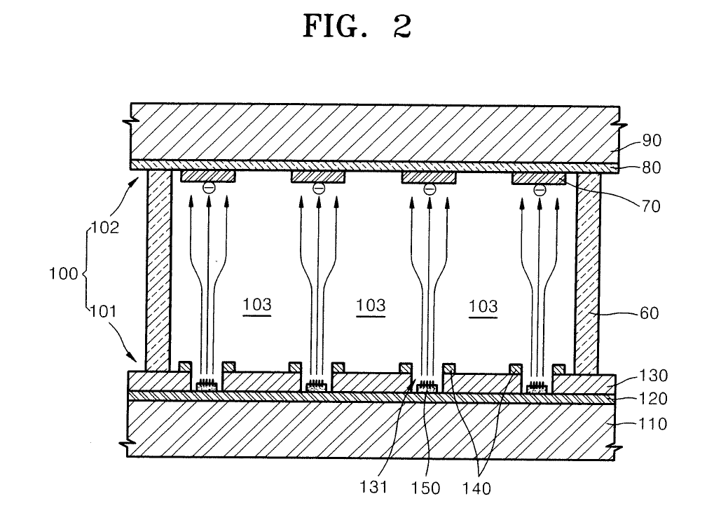

FIG. 1 is a schematic, partially-cut perspective view of a structure of an electron emission type backlight unit 100 according to an embodiment of the present invention, and FIG. 2 is a cross-sectional view of the electron emission type backlight unit 100 taken along the line II-II of FIG. 1.

Referring to FIGS. 1 and 2, the electron emission type backlight unit 100 according to the current embodiment of the present invention includes an electron emission device 101 and a front panel 102 located in front of the electron emission device 101.

The electron emission device 101 includes a base substrate 110, cathodes 120, gate electrodes 140, an insulating layer 130, and electron emission sources 150.

The base substrate 110 is a board member having a predetermined thickness and may be a glass substrate such as quartz glass, glass containing small amounts of impurities such as Na, sheet glass, glass coated with SiO₂, an oxide aluminum substrate, or a ceramic substrate. In order to realize a flexible display apparatus, in one embodiment, the base substrate 110 may be formed of a flexible material.

The cathodes 120 extend in a first direction on the base substrate 110 and may be formed of a conventional electrically conductive material, for example, a metal such as Al, Ti, Cr, Ni, Au, Ag, Mo, W, Pt, Cu, Pd, or an alloy of these materials, a metal oxide such as RuO₂, a printed conductive material including a metal oxide and glass, a transparent conductive material such as ITO, In₂O₃, or SnO₂, or a semiconductor material such as polysilicon, but the cathode material of the present invention is not limited thereto. In particular, when it is desired to transmit light from the rear of the base substrate 110, the cathodes 120 may be formed of a transparent conductive material such as ITO, In₂O₃, or SnO₂.

One end of each of the cathodes 120 is divided into two parts: a first electrode portion 121 and a second electrode portion 122. A resistance layer 123 is formed at (or near) an end of the first electrode portion 121. The first electrode portion 121 is the main electrode portion of each of the cathodes 120. The end of the first electrode portion 121 on which the resistance layer 123 is located electrically contacts a wiring portion 191 of a signal transmission unit 190, such as a flexible printed cable or a chip-on-film. The resistance layer 123 may be formed by depositing and patterning a metal material, for example, by performing a thin-film or a thick-film formation process or by screen printing of a metal paste. The second electrode portion 122 is branched from one side of the first electrode portion 121. The second electrode portion 122 serves as a bypass electrode through which current flows when an aging operation is performed.

The electron emission type backlight unit 100 of FIG. 1 includes the first electrode portion 121 and the second electrode portion 122, which are formed at one end of each of the cathodes 120. Current flows through the second electrode portion 122 as a bypass electrode when an aging operation is performed so that post-processing effects can be improved or maximized. Current flows through the first electrode portion 121 on which the resistance layer 123 is formed when a driving operation is performed, so that uniformity between pixels can be improved.

In other words, when an aging operation is performed, the wiring portion 191 of the signal transmission unit 190 is electrically connected to the second electrode portion 122, and when a driving operation is performed, the wiring portion 191 of the signal transmission unit 190 is moved laterally so that the wiring portion 191 is electrically connected to the first electrode portion 121 on which the resistance layer 123 is formed.

Uniformity between pixels can be improved by a resistance layer formed at one end of each of a plurality of data lines, and on the same electron emission device, a post-processing process, such as aging or firing, can be performed using the second electrodes on which a resistance layer is not formed, so that post-processing efficiency can be improved. Since, the resistance layer is formed only at one end of each data line, a process of manufacturing such an electron emission device is simplified and manufacturing costs are reduced. Additionally, resistance values can be easily changed. Thus, uniformity between pixels can be easily realized by using a resistance value (e.g., optimum resistance value) chosen for driving operation.

The insulating layer 130 is located between the gate electrodes 140 and the cathodes 120 to insulate the gate electrodes 140 from the cathodes 120, thereby preventing short circuits between the gates electrodes 140 and the cathodes 120. Electron emission source holes 131 are formed in the insulating layer 130 in regions where the gate electrodes 140 and the cathodes 120 cross one another. The electron emission sources 150 are located in the electron emission source holes 131.

The electron emission sources 150 are electrically connected to the cathodes 120 and formed to a height that is lower than the top surface of the gate electrodes 140. The electron emission sources 150 may be formed of any suitable material having any suitable shape (e.g., needle shape). In particular, the electron emission sources 150 may be formed of a carbon material such as carbon nanotubes (CNTs) having a low work function and a high β function, graphite, diamond, diamond like carbon (DLC), or a nanomaterial such as nanotubes, nanowires, or nanorods. In particular, CNTs have an electron emission characteristic that enables an electron emission display device to be driven with a low voltage. Therefore, the use of CNTs as an electron emission source is suitable for manufacturing a large screen display device.

In the electron emission device 101, a negative voltage is applied to the cathodes 120 and a positive voltage is applied to the gate electrodes 140 so that the electron emission sources 150 emit electrons due to an electric field between the cathodes 120 and the gate electrodes 140.

The front panel 102 includes a phosphor layer 70. The phosphor layer 70 is formed of a cathode luminescence (CL) type of phosphor material that can generate visible light when the phosphor layer 70 is excited by accelerated electrons. The phosphor material of the phosphor layer 70 may be, for example, a red color phosphor material such as SrTiO₃:Pr, Y₂O₃:Eu, Y₂O₃S:Eu, or the like, a green color phosphor material such as Zn(Ga, Al)₂O₄:Mn, Y₃(Al, Ga)₅O₁₂:Tb, Y₂SiO₅:Tb, ZnS:Cu, Al, or the like, and a blue color phosphor material such as Y₂SiO₅:Ce, ZnGa₂O₄, ZnS:Ag, Cl, or the like, but the phosphor material of the present invention is not limited thereto.

The front panel 102 may also include a front substrate 90 and an anode 80 installed on the front substrate 90. The front substrate 90 is a board member having a thickness (e.g., predetermined thickness) that is substantially the same as the thickness of the base substrate 110 and may be formed of the same material as the base substrate 110. The anode 80 is formed of a conventional electrically conductive material like the cathodes 120 and the gate electrodes 140. In particular, the anode 80 may be a transparent electrode so that light generated from the phosphor layer 70 can be transmitted through the anode 80.

The electron emission device 101 including the base substrate 110 and the front panel 102 including the front substrate 90 maintain a distance (e.g., predetermined distance) from each other and face each other to form a vacuum space 103. Spacers 60 are located between the electron emission device 101 and the front panel 102 to maintain the distance between the electron emission device 101 and the front panel 102 and may be formed of an insulating material.

Operation of the electron emission type backlight unit 100 having the above structure will now be described. A negative voltage is applied to the cathodes 120 and a positive voltage is applied to the gate electrodes 140 so that the electron emission sources 150, which are electrically connected to the cathodes 120, emit electrons. Also, a high positive voltage is applied to the anode 80 to accelerate the electrons towards the anode 80. When the high positive voltage is applied to the anode 80, the electrons emitted from the electron emission sources 150 move towards the gate electrodes 140, and then the electrons are accelerated towards the anode 80. The electrons that are accelerated towards the anode 80 collide with the phosphor layer 70 located on the anode 80. Then the phosphor material of the phosphor layer 70 is excited and emits visible light.

Hereinafter, a method of fabricating the electron emission device will be described. The method of fabricating the electron emission device of FIG. 1 includes forming electrodes on a base substrate, forming a resistance layer on one end of the electrodes, performing an aging operation without current flowing through the resistance layer, and electrically connecting a circuit to the electrodes for driving the electron emission device with current flowing through the resistance layer.

First, cathodes 120 are formed on a base substrate 110. The cathodes 120 extend in a first direction on the base substrate 110 and may be formed of a conventional electrically conductive material.

The cathodes 120 include a first electrode portion 121 and a second electrode portion 122. That is, one end of each of the cathodes 120 is divided into two parts. The second electrode portion 122, which is the branch electrode portion of each of the cathodes 120, is branched from one side of the first electrode portion 121, which is the main electrode portion of each of the cathodes 120. The second electrode portion 122 acts as a bypass electrode through which current flows when an aging operation is performed.

Next, a resistance layer 123 is formed at (or near) the end of the first electrode portion 121, which is the main electrode portion of each of the cathodes 120. The resistance layer 123 may be formed by depositing and patterning a metal material by performing a thin-film formation process or a thick-film formation process, or by screen printing of a metal paste, etc.

Next, an insulating layer 130 is formed on the base substrate 110 and the cathodes 120. Then gate electrodes 140 are formed on the insulating layer 130, electron emission source holes 131 are formed in regions in which the gate electrodes 140 and the cathodes 120 cross one another, and electron emission sources 150 are formed in the electron emission source holes 131.

Next, an aging operation is performed without current flowing through the resistance layer 123. That is, a wiring portion 191 of a signal transmission unit 190 is electrically connected to the second electrode portion 122, which is the bypass electrode, when the aging operation is performed, and current flows through the second electrode portion 122 so that post-processing effects can be improved or maximized.

Last, the circuit for driving the electron emission device is electrically connected to the electrodes so that current flows through the resistance layer 123. That is, when a driving operation is performed, the wiring portion 191 of the signal transmission unit 190 is moved laterally so that the wiring portion 191 is electrically connected to the first electrode portion 121 on which the resistance layer 123 is formed. As such, current flows through the first electrode portion 121 on which the resistance layer 123 is formed so that uniformity between pixels is improved.

According to an embodiment of the present invention, uniformity between pixels can be improved due to a resistance layer formed on one end of each of a plurality of data lines and on the electron emission device, a post-processing process, such as aging or firing, can be performed by using second electrodes on which a resistance layer is not formed, so that a post-processing efficiency is improved.

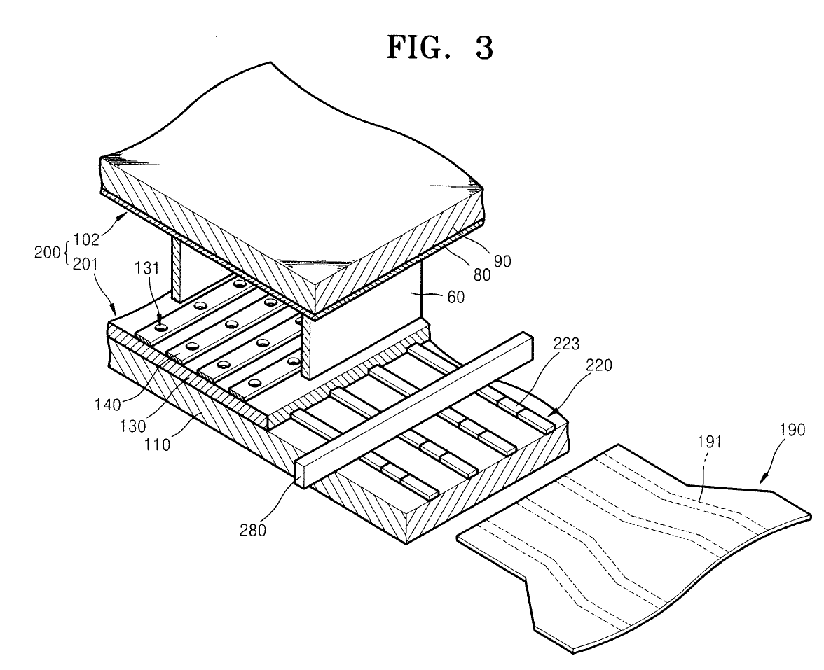

FIG. 3 is a schematic, partially-cut perspective view of a structure of an electron emission type backlight unit 200 according to another embodiment of the present invention. Referring to FIG. 3, the electron emission type backlight unit 200 according to the current embodiment of the present invention includes an electron emission device 201 and a front panel 102 that is located in front of the electron emission device 201. The electron emission device 201 includes a base substrate 110, cathodes 220, gate electrodes 140, and electron emission devices (e.g., electron emission device 150 of FIG. 2) located in electron emission source holes 131. The cathodes 220 extend in a first direction on the base substrate 110. The electron emission sources are located on the cathodes 220 and are electrically connected to the cathodes 220. An insulating layer 130 is interposed between the gate electrodes 140 and the cathodes 220. A resistance layer 223 is formed at (or near) the ends of the cathodes 220.

The present embodiment differs from the embodiment of FIG. 1 in how current bypasses the resistance layer 223 when an aging operation is performed. When an aging operation is performed, a shorting bar 280 is located on the cathodes 220 and does not allow current to flow through the resistance layer 223 so that post-processing effects can be maximized. When a driving operation is performed, the shorting bar 280 is removed and current flows through the resistance layer 223 so that uniformity between pixels is improved.

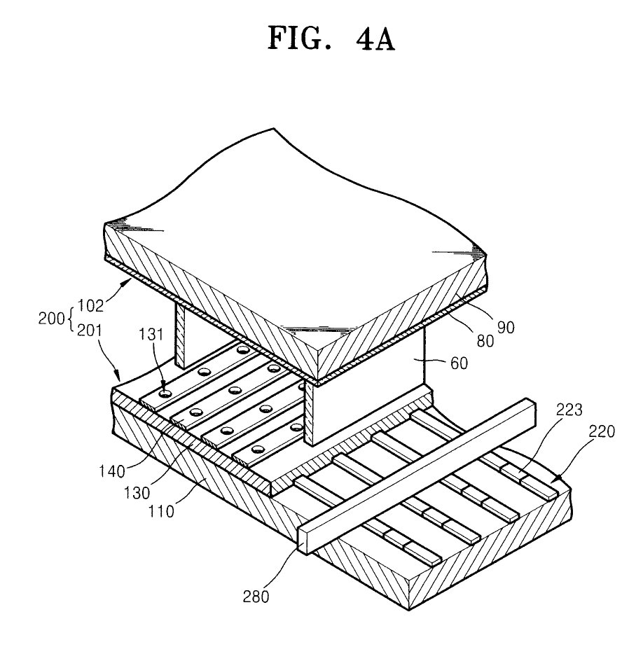

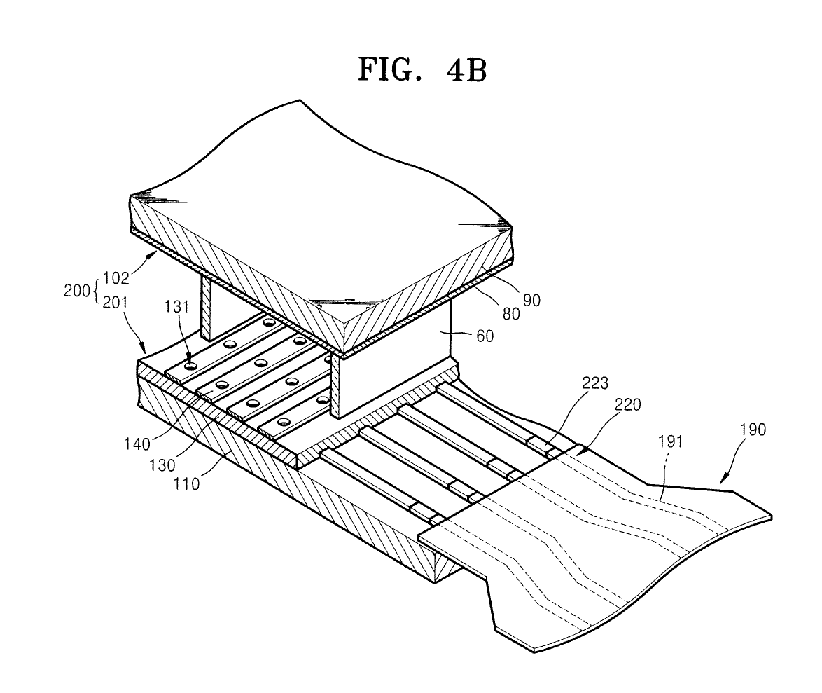

FIGS. 4A and 4B are schematic perspective views for explaining operations of the electron emission type backlight unit 200, according to embodiments of the present invention. Referring to FIG. 4A, when an aging operation is performed, the shorting bar 280 is located on the cathodes 220. In this case, the shorting bar 280 is located across the cathodes 220. Then, when a high voltage is applied to the shorting bar 280 to perform the aging operation, current flow bypasses the resistance layer 223. Thus, when the aging operation is performed, post-processing efficiency is not reduced by the resistance layer 223.

In addition, referring to FIG. 4B, when a driving operation is performed, the shorting bar 280 is removed and the wiring portion 191 of the signal transmission unit 190 is electrically connected to the cathodes 220 on which the resistance layer 223 is formed, so that uniformity between pixels is improved.

Hereinafter, a method of fabricating the electron emission device will be described. The method of fabricating the electron emission device of FIG. 3 includes forming electrodes on a base substrate, forming a resistance layer on one end of the electrodes, performing an aging operation without current flowing through the resistance layer, and electrically connecting a circuit for driving the electron emission device to the electrodes so that current flows through the resistance layer.

First, cathodes 220 are formed on a base substrate 110. The cathodes 220 extend in a first direction on the base substrate 110 and may be formed of a conventional electrically conductive material.

Next, a resistance layer 223 is formed at (or near) the ends of the cathodes 220. The resistance layer 223 may be formed by depositing and patterning a metal material by performing a thin-film formation process or a thick-film formation process, or by screen printing of a metal paste, etc.

Next, an insulating layer 130 is formed on the base substrate 110 and the cathodes 220. Then gate electrodes 140 are formed on the insulating layer 130, electron emission source holes 131 are formed in the insulating layer 130 in regions where the gate electrodes 140 and the cathodes 220 cross one another, and electron emission sources (e.g., electron emission sources 150 of FIG. 2) are formed in the electron emission source holes 131.

Next, an aging operation is performed in a manner so that current does not flow through the resistance layer 223. Specifically, when the aging operation is performed, a shorting bar 280 is placed on the cathodes 220. In this case, the shorting bar 280 is placed to cross the cathodes 220. Then, when a high voltage is applied to the shorting bar 280 to perform the aging operation, current does not flow through the resistance layer 223. Thus, the resistance layer 223 does not reduce post-processing efficiency by limiting current flow during the aging operation.

Last, a circuit for driving the electron emission device is electrically connected to the electrodes so that current flows through the resistance layer 223. In other words, when a driving operation is performed, the shorting bar 280 is removed, and a wiring portion 191 of a signal transmission unit 190 is electrically connected to the cathodes 220 on which the resistance layer 223 is formed. Thus, current flows through the resistance layer 223 so that uniformity between pixels may be improved.

According to an embodiment of the present invention, uniformity between pixels is improved due to a resistance layer formed near one end of each of a plurality of data lines and on the same electron emission device, a post-processing process, such as aging or firing, can be performed by using second electrodes on which a resistance layer is not formed, so that post-processing efficiency can be improved or maximized. Current does not flow through the resistance layer during post-processing so that post-processing effects can be maximized; however, current flows through the resistance layer during driving so that uniformity between pixels can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electron emission device comprising:
a base substrate;
first electrodes extending in a first direction on the base substrate, each first electrode comprising a resistance layer at an end of the first electrode;
second electrodes electrically insulated from the first electrodes; and
electron emission sources on the first electrodes, wherein it is variable whether or not current flows through the resistance layer.

2. The electron emission device of claim 1, wherein the device is configured so that current does not flow through the resistance layer when an aging operation is performed and current flows through the resistance layer when a driving operation is performed.

3. The electron emission device of claim 1, wherein the resistance layer is on a first portion of each of the first electrodes, and each first electrode further comprises a second portion protruding from one side of the first portion.

4. The electron emission device of claim 3, wherein the device is configured so that when an aging operation is performed, current flows through the second portion and when a driving operation is performed, current flows through the first portion.

5. The electron emission device of claim 3, wherein the device is configured so that when an aging operation is performed, a circuit for driving the electron emission device is electrically connected to the second portion and when a driving operation is performed, the circuit for driving the electron emission device is electrically connected to the first portion.

6. The electron emission device of claim 1, further comprising a shorting bar crossing and electrically connecting the first electrodes.

7. The electron emission device of claim 6, wherein, the shorting bar is located at one side of the resistance layer so that current does not flow through the resistance layer when an aging operation is performed.

8. An electron emission type backlight unit comprising:
an electron emission device comprising:
a base substrate;
first electrodes extending in a first direction on the base substrate, each first electrode comprising a resistance layer at an end of the first electrode;
second electrodes electrically insulated from the first electrodes; and
electron emission sources on the first electrodes;
a phosphor layer facing each of the electron emission sources of the electron emission device; and
a third electrode for accelerating electrons emitted from the electron emission device toward the phosphor layer.

9. A method of fabricating an electron emission device, the method comprising:
forming electrodes on a base substrate;
forming a resistance layer at one end of each of the electrodes;
performing an aging operation without current flowing through the resistance layer; and
electrically connecting a circuit for driving the electron emission device to the electrodes so that current flows through the resistance layer.

10. The method of claim 9, wherein each of the electrodes comprises a first portion on which the resistance layer is formed and a second portion protruding from one side of the first portion.

11. The method of claim 10, wherein, in the performing of the aging operation, current flows through the second portion, and in the electrically connecting of the circuit for driving the electron emission device to the electrodes, current flows through the first portion.

12. The method of claim 10, wherein, in the performing of the aging operation, the circuit for driving the electron emission device is electrically connected to the second portion, and in the electrically connecting of the circuit for driving the electron emission device to the electrodes, the circuit for driving the electron emission device is electrically connected to the first portion.

13. The method of claim 9, further comprising:
before the performing an aging operation, disposing a shorting bar across the first electrodes; and
after the performing of the aging operation, removing the shorting bar.

14. The method of claim 13, wherein the shorting bar does not allow current to flow through the resistance layer.
